(19) United States
(12) Patent Application Publication
(10) Pub. No.: US 2011/0075562 A1
(43) Pub. Date: Mar. 31, 2011

(54) Rate Shaping For Wireless Communication Using Token Bucket That Allows Token Debt

(76) Inventors: Martin Isaksson, Stockholm (SE); Magnus Hurd, Stockholm (SE); Henning Wiemann, Aachen (DE)

(21) Appl. No.: 12/820,557

(22) Filed: Jun. 22, 2010

Related U.S. Application Data
(60) Provisional application No. 61/245,933, filed on Sep. 25, 2009.

(51) Int. Cl. H04L 12/26

(52) U.S. Cl. 370/235.1

(57) ABSTRACT

A modified token bucket algorithm in a rate shaping function of a wireless communication network allows for the “borrowing” of tokens, creating the possibility of a token debt, or a token bucket with a negative Token Bucket Counter (TBC) value. In this modified algorithm, an incoming packet is passed along so long as the TBC is positive, even if the packet must “borrow” some tokens, driving the TBC negative. Subsequent incoming packets are stalled until the TBC reaches a positive value. In one embodiment, the modified token bucket algorithm is not applied to a separate rate shaper, but rather to a queue size limiter that operates with a scheduler on a single queue. The inventive scheduler and queue size limiter deliver fewer, larger packets for transmission, allowing for more efficient packing within transmission frames (reducing or eliminating required padding), and allowing other traffic to be scheduled, thus increasing system throughput.

This application claims priority to U.S. Provisional Application Ser. No. 61/245,933, titled “Rate Shaping for Wireless Communication Using Token Bucket That Allows Token Debt,” filed Sep. 25, 2009, the disclosure of which is incorporated herein by reference in its entirety.

### FIELD OF THE INVENTION

The present invention relates generally to wireless communication networks, and in particular to rate shaping using a modified token bucket algorithm, wherein a token bucket counter value is allowed to go negative, creating a token debt.

### BACKGROUND

Wireless communication systems are a ubiquitous part of modern life in many areas. A number of different wireless communication protocols have been developed. For example, Long Term Evolution (LTE) is a set of enhancements to the Universal Mobile Telecommunications System (UMTS) that supports high data rates, low latency, low implementation and operating costs, and a seamless connection to legacy wireless communication networks.

As another example, High Speed Packet Access (HSPA) is an extension of wideband CDMA (WCDMA) protocols. HSPA transmits communication data on shared channels, in packets addressed to specific users. HSPA features short Transmission Time Interval (TTI), link adaptation, fast scheduling, fast retransmission and soft-combining, and advanced modulation, resulting in increased data rates, low latency, and increased system capacity.

In LTE and HSPA, as well as other wireless communication protocols, scheduling, segmentation, and link adaptation are network management tasks that fall under the broad rubric of bandwidth management. Advanced bandwidth management techniques are required to maximize system capacity; maintain Quality of Service (QoS) metrics; and maximize the data rate, and hence provide an optimal user experience, to each user.

One aspect of bandwidth management is known as rate shaping, which controls the rate or flow of data into or through a network. A known rate shaping algorithm is the so-called token bucket algorithm, described in Annex B of the 3GPP Technical Standard 23.107, “Quality of Service (QoS) concept and architecture,” attached hereto and incorporated herein by reference in its entirety. The token bucket algorithm is described with reference to FIG. 1. Briefly, the algorithm posits a hypothetical bucket, filled with tokens at a constant token rate r corresponding to a data rate, which may for example be defined by a traffic contract or other system specification. The number of tokens in the bucket is represented by, e.g., a Token Bucket Counter (TBC). The bucket has a maximum capacity b, for example corresponding to a bounded burst size. Packets presented to the rate shaper for transmission in a wireless network are deemed conformant, and are passed along for transmission across the air interface, if there are at least as many tokens in the bucket as the packet size (e.g., in bytes). If not, the packet is delayed until the bucket fills with sufficient tokens. Data are thus conformant if the data sent in an arbitrary time period, T, do not exceed b+rT. The resulting transmission data rate, R, is on average the token rate, r.

FIG. 2 depicts the operation of the token bucket algorithm. Initially, the bucket is assumed full, with TBC=b. A first packet, of length l₁, is conformant (sufficient tokens are in the bucket), and it is passed to the wireless network for transmission. The bucket fills at a constant rate over the next interval ΔT=t₂−t₁, until a second packet, of length l₂, arrives. The second packet is also conformant (it is smaller than the number of tokens in the bucket, or l₂<TBC), and the packet is passed by the rate shaper. A third packet arrives, of length l₃, when the bucket contains just enough tokens to pass it as well—completely or nearly depleting the bucket (TBC at or near 0). A fourth packet, of length l₄, arrives at time t₄, before the bucket has been sufficiently replenished with tokens. The fourth packet is delayed by the rate shaper until TBC>=l₄, indicated in FIG. 2 as “Packet delay.”

The packets that pass the rate shaper are collected in one or more queues until they are scheduled for transmission over a subsequent link. In state-of-the-art solutions the scheduling algorithm chooses packets based on the availability in these queues, i.e., the packets that have passed the rate shaper. Furthermore, systems exist where the scheduler can not only decide to transfer an entire packet but to segment (and concatenate) packets prior to transmission.

FIG. 3A depicts a rate shaping function 10, comprising an input buffer 12, rate shaper 14, scheduling buffer 16, and scheduler 18. FIG. 3B depicts a representative scheduling of packets for transmission in a wireless network. The scheduling, including any segmentation and concatenation, is limited to the packets in the scheduling buffer 16—that is, those packets that passed the rate shaper 14. The strict rate shaper 14 limitation leads to frequent but small data transmissions. Due to the granularity of frame sizes that can be scheduled, padding is likely to occur, which reduces the network throughput. Hence, the scheduling of frequent, small data packets is not optimal in a wireless communication system.

### SUMMARY

According to one or more embodiments described and claimed herein, a modified token bucket algorithm allows for the “borrowing” of tokens, creating the possibility of a token debt, or a token bucket with a negative TBC value. In this modified token bucket algorithm, an incoming packet is passed along so long as the TBC is positive, even if the packet must “borrow” some tokens, driving the TBC negative. Subsequent incoming packets are stalled until the TBC reaches a positive value. In one embodiment, the modified token bucket algorithm is not applied to a separate rate shaper, but rather to a queue size limiter that operates with a scheduler on one or more traffic queues. The inventive scheduler and queue size limiter deliver fewer, larger packets for transmission, allowing for more efficient packing within transmission frames (reducing or eliminating required padding), and allowing other traffic to be scheduled, thus increasing system throughput.

One embodiment relates to a method of controlling traffic flow in a wireless communication network. One or more data packets are accepted into a traffic queue, for transmission. The traffic queue is monitored by a queue size limiter using a modified token bucket rate shaping algorithm. The modified algorithm comprises maintaining a token bucket counter (TBC) representing the number of tokens in a bucket; decreasing the TBC by the size of each packet scheduled for transmission; and increasing the TBC at a constant token rate. If the TBC is positive, the queue size limiter reports to a scheduler the size of the packet(s) in the traffic queue. If the TBC is negative, the queue size limiter reports to the scheduler that the traffic queue is empty. The scheduler schedules the reported packets for transmission.

Another embodiment relates to a rate shaping function in a transmitter operative in a wireless communication network. The rate shaping function includes a traffic queue operative to receive and store data packets to be transmitted across an air interface. The rate shaping function further includes a queue size limiter operative to monitor the queue and control the flow of data packets from the queue to a scheduler, the queue size limiter using a modified token bucket rate shaping algorithm. The modified algorithm comprises maintaining a token bucket counter (TBC) representing the number of tokens in a bucket; decreasing the TBC by the size of each packet scheduled for transmission; and increasing the TBC at a constant token rate. If the TBC is positive, the queue size limiter reports to the scheduler the size of the packet(s) in the traffic queue. If the TBC is negative, the queue size limiter reports to the scheduler that the traffic queue is empty. The rate shaping function also includes a scheduler operative to schedule data packets from the traffic queue for transmission across the air interface, in response to the queue size limiter.

### BRIEF DESCRIPTION OF THE DRAWINGS

FIG. 1 is a functional block diagram of a conventional token bucket algorithm for a rate shaper.

FIG. 2 is a graph depicting the operation of a conventional token bucket algorithm in a rate shaper.

FIG. 3A is functional block diagram of queues controlled by a rate shaper and scheduler.

FIG. 3B is a graph of traffic in a wireless network controlled by the rate shaper and scheduler of FIG. 3A.

FIG. 4 is a graph depicting the operation of a modified token bucket algorithm with token debt, in a rate shaper.

FIG. 5A is functional block diagram a queue controlled by a queue size limiter and scheduler.

FIG. 5B is a graph of traffic in a wireless network controlled by the queue size limiter and scheduler of FIG. 5A.

FIG. 6 is a diagram of packets and overhead passed between network protocol layers for conventional and modified token bucket algorithms.

FIG. 7 is a graph comparing the operation of conventional and modified token bucket algorithms in a rate shaper.

FIG. 8 is a flow diagram of a method of downlink rate shaping using a modified token bucket algorithm with token debt.

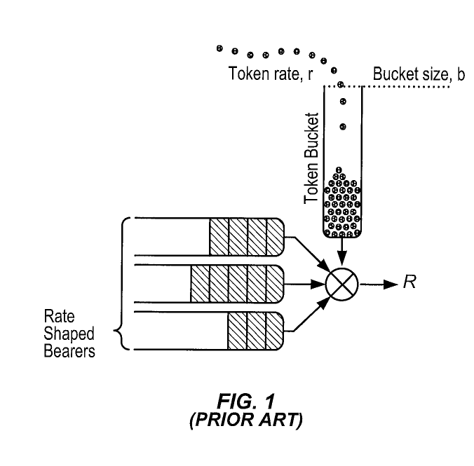

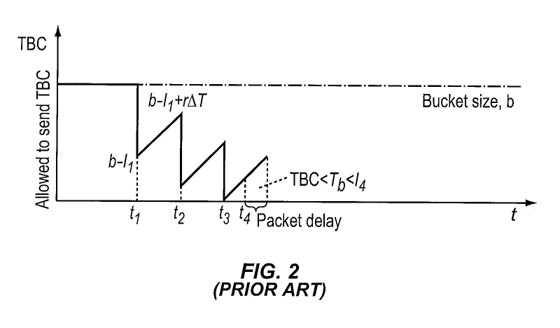

### DETAILED DESCRIPTION

A rate shaper in a wireless communication network is often implemented with a conventional token bucket algorithm. As described above, the basis for this algorithm is that hypothetical tokens, representing the allowed data volume, are injected at a constant rate. These tokens accumulate in a hypothetical bucket, and the maximum allowed number of tokens is defined by the bucket size. The tokens are consumed by data packets passing the rate shaper for transmission, which occurs only if there are at least as many tokens in the bucket as the packet size.

According to embodiments of the present invention, rate shaping is implemented using a modified token bucket algorithm, in which the concept of borrowing tokens is introduced. In the modified token bucket algorithm, a packet is allowed to create a token debt, resulting in a negative token bucket counter (TBC) value. After creating such a token debt, the rate shaper will not pass any further packets until the TBC has resumed a positive value. Thus, the borrowing will create a delay before the next transmission is allowed. The lower bound on the TBC is −c so that the TBC is within the range [−c,b]. In some embodiments, the TBC may also be bounded by the available radio channel.

In an exemplary embodiment, the TBC is increased by r in each unit time up to the bucket size, b. In another embodiment, the TBC is increased by Δt·r where Δt is the time difference between the current time and the previous update of the TBC.

When the l^{th} packet with length lᵢ; arrives the algorithm checks if the TBC value is equal or greater than zero. If so then traffic is conformant and TBC is decreased by lᵢ (even if TBC<lᵢ). If the TBC is less than zero, the packet is delayed until the TBC is equal or greater than zero.

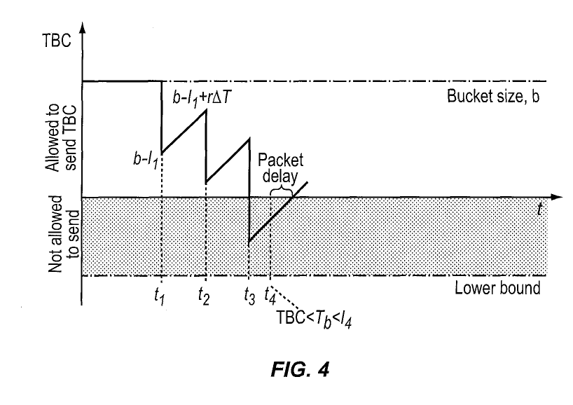

The operation of this modified token bucket algorithm is depicted in FIG. 4. Four packets with lengths l₁, l₂, l₃, and l₄ arrive, of which the first two are conformant and therefore processed immediately, as in the conventional token bucket algorithm. The third is conformant under the modified token bucket algorithm, but it makes the TBC go below zero. When the fourth packet arrives at t₄, TBC<0, so the packet is delayed until the TBC is greater than zero, as indicated in FIG. 4 by the “Packet delay” duration.

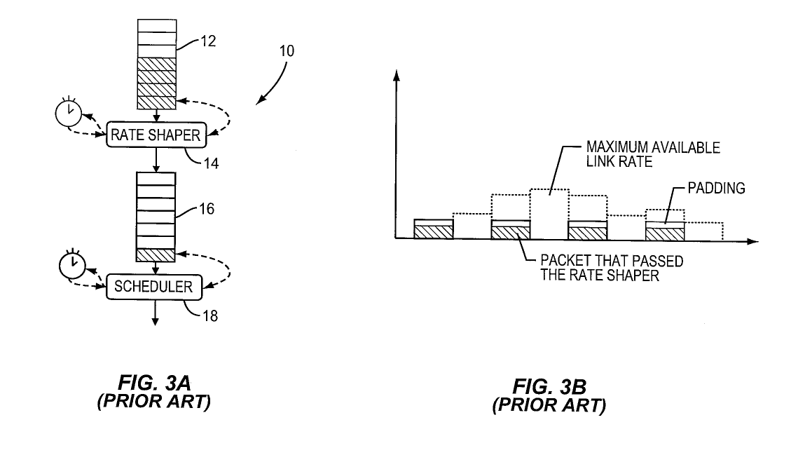

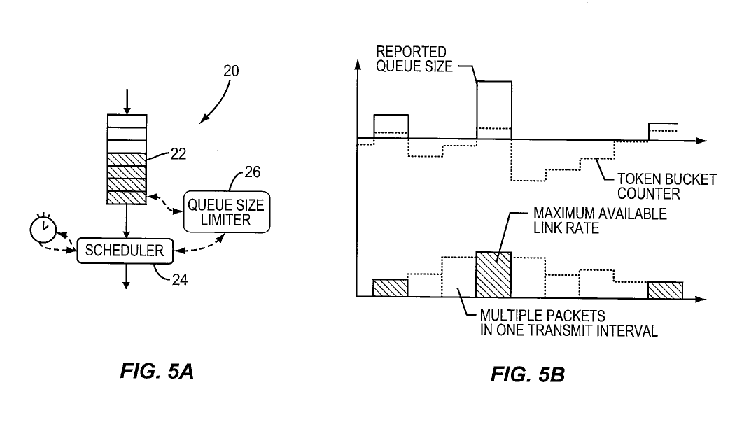

In one embodiment, depicted in FIG. 5A, a rate shaping function 20 implements the modified token bucket algorithm in a queue size limiter 26, rather than in the stand-alone rate shaper 14 depicted in FIG. 3A. In this embodiment, there is no separate input buffer 12 or independent rate shaper 14, but rather a single traffic queue 22. In other embodiments, the scheduler 24 could rate shape traffic from multiple queues, each of which may have an independent queue size limiter, or may share a common queue size limiter. The traffic queue 22 accommodates all incoming packets and also serves the outgoing link. A scheduler 24 has no immediate knowledge about the amount of data in the traffic queue 22, but obtains this information from the queue size limiter 26. The modified token bucket algorithm reports the actual queue size (or, in one embodiment, the upper bound to c) whenever the TBC≧0. Otherwise, the queue size limiter 26 reports to the scheduler 24 that the traffic queue 22 is empty, and thereby prevents any transmission.

Those of skill in the art will readily recognize that the scheduler 24 and queue size limiter 26 of the rate shaping function 20 may be implemented in dedicated hardware, programmable logic with appropriate firmware, software executing on a controller or processor (e.g., a Digital Signal Processor, or DSP), or any combination thereof. The traffic queue 22 may be implemented as hardware registers, or in memory. Firmware or software controlling the queue 22 or implementing the scheduler 24 or queue size limiter 26 may be stored on non-transient computer-readable media, such as solid-state memory (e.g., Flash RAM, DRAM, ROM, or the like), magnetic or optical media, or the like. The firmware or software may be accessed by a controller or processor directly, via a controller such as a memory controller or disc drive controller, or across a wired or wireless network from remote computer readable media.

The graph of FIG. 5B shows that the rate shaping function 20 utilizes wireless network resources more efficiently than prior art rate shapers (e.g., FIG. 3A). The upper graph depicts the TBC value (dashed line) and the reported traffic queue 22 size (solid line). Note that the actual traffic queue 22 size is only reported if the TBC is non-negative; it reports an empty traffic queue 22 otherwise. The lower graph depicts traffic passed by the scheduler for transmission across the air interface. Note that, compared to the graph of FIG. 3B, the rate shaping function 20, implementing the modified token bucket algorithm with borrowed tokens, passes fewer transmissions, each of which is larger, and hence requires little or no padding. This increases system throughput, in part by allowing allocation of transmission resources to other queues or users.

Furthermore, the embodiment depicted in FIG. 5A allows for a simpler implementation, as it requires only a single traffic queue 22. This is particularly desirable in combination with other control algorithms such as Active Queue Management (AQM). In contrast, the prior art solution depicted in FIG. 3A requires two, independent AQM mechanisms, one controlling the queue 12 upstream of the rate shaper 14, and one controlling the queue 16 upstream of the scheduler 18.

In the modified token bucket algorithm, the maximum number of tokens, b, is determined by the parameter bucketTime [s] so that b=r·bucketTime. The parameter bucketTime corresponds to the time it is possible to save tokens to be consumed in a burst which does not cause any debt. In other words, a rate shaper employing the modified token bucket algorithm allows data bursts that comprise as much data as what may be sent in steady state with a constant rate, r, for the duration of

$$\frac{b + c}{r} .$$

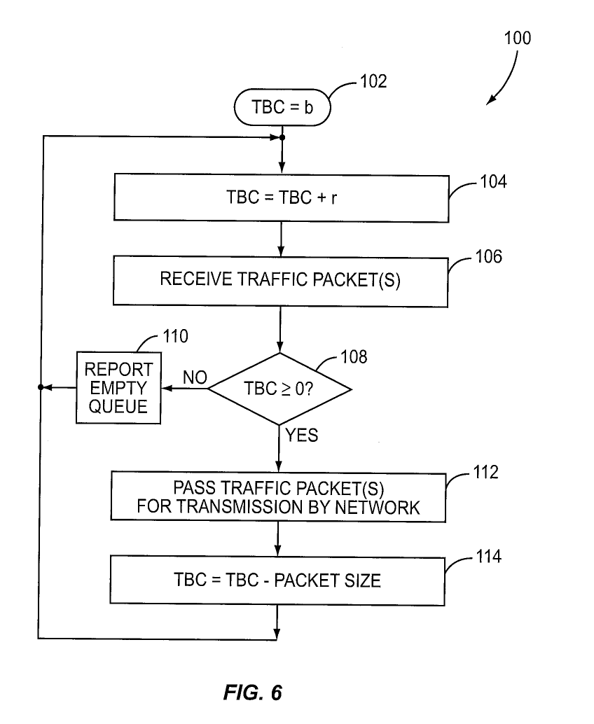

FIG. 6 depicts a method 100 of rate shaping in a queue size limiter 26 based on a modified token bucket algorithm. Initially, the Token Bucket Counter (TBC) is set to b (block 102) representing the maximum number of tokens it can hold. The TBC is incremented at a constant token rate r (block 104). The increase in TBC is depicted as a discrete block 104; however, those of skill in the art will recognize that the TBC is incremented at a constant rate, regardless of the flow of control through the flow diagram of FIG. 14. In one embodiment, for example, the TBC is incremented each TTI. A single traffic queue 22 receives one or more data packets of user traffic (block 106). If the TBC is greater than or equal to zero (block 108), the packets are deemed conformant, and the queue size is passed to a scheduler 24 for scheduling transmission by the network (block 112). The TBC is decremented by the packet size (block 114), even if this reduces the TBC to a negative value, representing “borrowed” tokens. If one or more traffic packets are received (block 106) and the TBC is negative (block 108), the queue size limiter 26 reports to the scheduler 24 that the traffic queue 22 is empty, and consequently no packets are scheduled for transmission.

The modified token bucket algorithm, with the possibility to borrow tokens, prevents the transfer of packets from one network layer to another in unnecessarily small sizes. Scheduling many small packets instead of a few large ones is an inefficient use of resources such as the Physical Downlink Control Channel (PDCCH) and the Physical Uplink Control Channel (PUCCH).

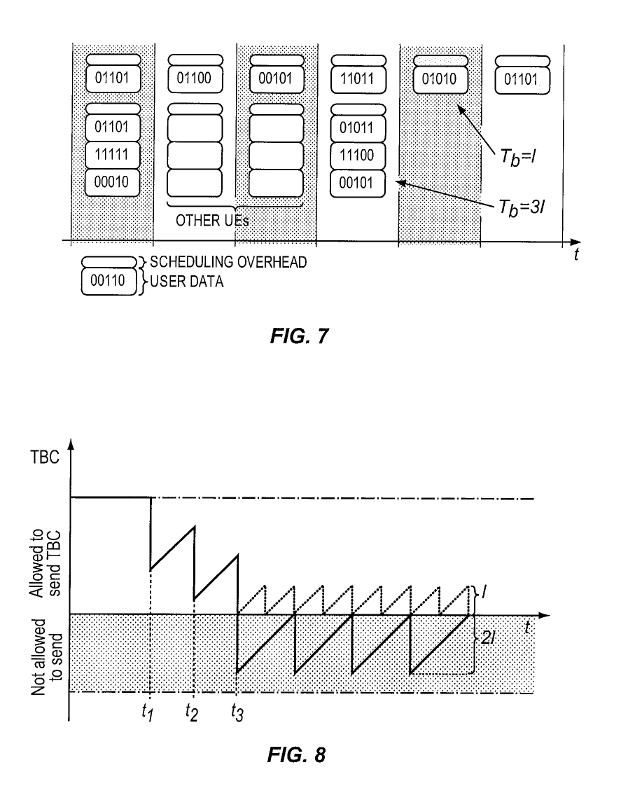

FIG. 7 depicts the effect of inter-layer data transfers with rate shaping using the conventional token bucket algorithm (upper portion) and the conventional token bucket algorithm that allows for borrowing tokens (lower portion). The ability to borrow tokens allows for numerous packets to be transferred to lower layers at once. This has numerous advantages. First, a main source of performance degradation is primarily scheduling overhead; as shown in the lower portion of FIG. 6, the scheduling overhead as a percentage of a transmission is reduced when numerous packets are included in the transmission. Second, by collecting multiple packets to or from a UE into one TTI, other TTIs (or slots, frames, or other defined transmission durations) are freed to carry traffic from or to other UEs.

FIG. 8 illustrates the difference in TBC value between the conventional and modified token bucket algorithms. Initially, when the bucket is full (TBC=b), the algorithms operate similarly. As the token count is depleted, however, the conventional algorithm (dashed-line) schedules numerous, short data transmissions for delivery to a UE. This is necessary, as each data packet (of length l) must await the collection of a sufficient token count. In contrast, in the modified token bucket algorithm (solid line) the queue size limiter 26 may borrow tokens, allowing the scheduler 24 to schedule half the number of transmissions, each of length 2l. The overall transmission is completed at the same time in both cases—that is, both solutions perform the desired rate shaping, but at different resource costs.

Key terms are defined as follows, and have the specified meaning as used herein:

Rate enforcement: Rate enforcement is the umbrella term for rate shaping and rate policing.

Rate policing: The process of discarding packets from a traffic stream in accordance with a traffic profile is called rate policing or traffic policing. Reasons to apply rate policing can be to protect the network from flooding attacks, enable tiered subscriptions and discourage cheating, e.g., users upgrade the VolP codec rate beyond that which has been authorized by the network.

Rate shaping: The process of delaying packets in a traffic stream to cause it to conform to some defined traffic profile is called rate shaping or traffic shaping. Reasons to apply rate shaping can be to smooth out traffic in time entering a network. The reasons to apply rate policing are valid also here. Rate shaping can be realized as an improvement to the scheduler.

Shaping rate: The rate resulting from the use of a rate shaper with a certain token rate. The shaping rate should on average be the token rate.

Traffic policing: See rate policing.

Traffic shaping: See rate shaping.

Token: Something serving as an expression of something else. Here a token is virtual sign corresponding to the smallest information unit size. Tokens arrive into the bucket at the token rate, r.

Token rate: The rate at which tokens are injected into the system.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of controlling traffic flow in a wireless communication network comprising:
accepting, into a traffic queue, one or more data packets for transmission;
monitoring the traffic queue by a queue size limiter using a modified token bucket rate shaping algorithm comprising
maintaining a token bucket counter (TBC) representing the number of tokens in a bucket;
decreasing the TBC by the size of each packet scheduled for transmission;
increasing the TBC at a constant token rate;
if the TBC is positive, reporting to a scheduler the size of the packet(s) in the traffic queue;
if the TBC is negative, reporting to the scheduler that the traffic queue is empty; and
scheduling the reported packets for transmission.

2. The method of claim 1 wherein the traffic queue, queue size limiter, and scheduler are in a network node, and wherein packets are scheduled for downlink transmission across an air interface to user equipment (UE).

3. The method of claim 1 wherein the traffic queue, queue size limiter, and scheduler are in user equipment (UE), and wherein packets are scheduled for uplink transmission across an air interface.

4. The method of claim 1 wherein increasing the TBC at a constant token rate comprises periodically incrementing the TBC by a predetermined amount.

5. The method of claim 4 wherein the TBC is incremented at each Transmission Time Interval (TTI).

6. The method of claim 1 wherein increasing the TBC at a constant token rate comprises increasing the TBC by an amount by Δt·r where Δt is the time difference between the current time and the previous update of the TBC and r is a predetermined constant.

7. The method of claim 1 wherein the maximum number of tokens is b, and wherein up to −c tokens may be borrowed at a time, and wherein tokens are added at a constant rate r, such that the modified token bucket algorithm allows data bursts that comprise as much data as what may be sent in steady state with a constant rate, r, for the duration of
$$\frac{b + c}{r} .$$

8. The method of claim 1 further comprising performing Active Queue Management (AQM) on the traffic queue.

9. A rate shaping function in a transmitter operative in a wireless communication network, comprising:
a traffic queue operative to receive and store data packets to be transmitted across an air interface;
a queue size limiter operative to monitor the queue and control the flow of data packets from the queue to a scheduler, the queue size limiter using a modified token bucket rate shaping algorithm comprising
maintaining a token bucket counter (TBC) representing the number of tokens in a bucket;
decreasing the TBC by the size of each packet scheduled for transmission;
increasing the TBC at a constant token rate;
if the TBC is positive, reporting to the scheduler the size of the packet(s) in the traffic queue; and
if the TBC is negative, reporting to the scheduler that the traffic queue is empty; and
a scheduler operative to schedule data packets from the traffic queue for transmission across the air interface, in response to the queue size limiter.

10. The rate shaping function of claim 9 wherein the transmitter is in a network node, and wherein packets are scheduled for downlink transmission across an air interface to user equipment (UE).

11. The rate shaping function of claim 9 wherein the transmitter is in user equipment (UE), and wherein packets are scheduled for uplink transmission across an air interface.

12. The rate shaping function of claim 9 wherein increasing the TBC at a constant token rate comprises periodically incrementing the TBC by a predetermined amount.

13. The rate shaping function of claim 12 wherein the TBC is incremented at each Transmission Time Interval (TTI).

14. The rate shaping function of claim 9 wherein increasing the TBC at a constant token rate comprises increasing the TBC by an amount by Δt·r where Δt is the time difference between the current time and the previous update of the TBC and r is a predetermined constant.

15. The rate shaping function of claim 9 wherein the maximum number of tokens is b, and wherein up to −c tokens may be borrowed at a time, and wherein tokens are added at a constant rate r, such that the modified token bucket algorithm allows data bursts that comprise as much data as what may be sent in steady state with a constant rate, r, for the duration of
$$\frac{b + c}{r} .$$

16. The rate shaping function of claim 9 further comprising performing Active Queue Management (AQM) controller operative to perform AQM on the traffic queue.

17. A non-transient computer-readable medium which stores computer-executable process steps for controlling traffic flow in a wireless communication network, the computer-executable process steps causing a controller to perform the steps of:
monitoring the traffic queue by a queue size limiter using a modified token bucket rate shaping algorithm comprising
maintaining a token bucket counter (TBC) representing the number of tokens in a bucket;
decreasing the TBC by the size of each packet scheduled for transmission;
increasing the TBC at a constant token rate;
if the TBC is positive, reporting to a scheduler the size of the packet(s) in the traffic queue;
if the TBC is negative, reporting to the scheduler that the traffic queue is empty; and
scheduling the reported packets for transmission.

18. The computer-readable medium of claim 17 wherein the controller is in a network node, and wherein packets are scheduled for downlink transmission across an air interface to user equipment (UE).

19. The computer-readable medium of claim 17 wherein the controller is in user equipment (UE), and wherein packets are scheduled for uplink transmission across an air interface.

20. The computer-readable medium of claim 17 wherein increasing the TBC at a constant token rate comprises periodically incrementing the TBC by a predetermined amount.

21. The computer-readable medium of claim 20 wherein the TBC is incremented at each Transmission Time Interval (TTI).

22. The computer-readable medium of claim 17 wherein increasing the TBC at a constant token rate comprises increasing the TBC by an amount by Δt·r where Δt is the time difference between the current time and the previous update of the TBC and r is a predetermined constant.

23. The computer-readable medium of claim 17 wherein the maximum number of tokens is b, and wherein up to −c tokens may be borrowed at a time, and wherein tokens are added at a constant rate r, such that the modified token bucket algorithm allows data bursts that comprise as much data as what may be sent in steady state with a constant rate, r, for the duration of
$$\frac{b + c}{r} .$$

24. The computer-readable medium of claim 17 wherein the computer-executable process steps further cause a controller to perform Active Queue Management (AQM) on the traffic queue.
